(19) United States
(12) Patent Application Publication
(10) Pub. No.: US 2009/0172548 A1
(43) Pub. Date: Jul. 2, 2009

(54) TACTILE TWO-WAY FEEDBACK TO REMOTE PRESENTATION CONTROLLER DEVICE TO INDICATE SLIDE ANIMATION STATUS

(75) Inventor: David Screen, Hampshire (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/965,168

(22) Filed: Dec. 27, 2007

(51) Int. Cl. G06F 3/00

(52) U.S. Cl. 715/732

(57) ABSTRACT

A presentation controller device is disclosed. A presentation is constructed with slides. At least one slide can include animations. In a manual operation, the controller device vibrates or provides a tactile feedback before a final animation on a current slide. Clicking a button on the controller device makes a transition (e.g., an animation transition, a slide transition). In an automatic operation, the controller device vibrates or provides a tactile feedback before an event (i.e., an animation transition, a slide transition, a final animation, a final slide). A sequence of slides/animations is automatically presented at a programmed time interval.

### BACKGROUND OF THE INVENTION

1. Field of the Invention

The present invention relates to a presentation tool for slide presentation systems. More particularly, the present invention relates to a presentation remote control device for a presentation tool.

2. Description of the Prior Art

A visual presentation such as generated by computer executed programs such as Microsoft® Powerpoint® or similar programs is typically constructed as a series of units herein referred to as slides. Each slide can have a series of animations or actions which appear as part of the slide presentation. An example is text sliding onto a currently displayed screen to gradually reveal more text on the slide. These transitions/actions can be timed in a pre-programmed sense (automatic—e.g. show each new animation/action after waiting 5 seconds) or triggered by the user (manual) via a control on the presentation device (e.g. a computer). Once all of the actions are completed, then the next slide can be shown. When triggered by the user, this is typically done by using the same key/mouse button as advances the slides. In some embodiments, a presentation control device (combined with a laser pointer sometimes) is used to do the “left mouse button clicking” remotely. A user's manipulating spacebar or page down key are alternatives to left clicking of a mouse device in Microsoft® Powerpoint®.

Thus, if a slide had two actions then, a series of steps that may be performed include:
a. {slide is displayed}
b. initiating presentation of a first action (click 1)
c. initiating presentation of a second action (click 2)
d. displaying next slides (click 3)

The problem with this prior art mechanism is that when “clicking” through the slide presentation animations, a user may not know when the final animation is. This causes the user to accidentally click onto the next slide when their intention is just to get to the final version of the slide after all of the actions have been performed. This distracts from the presentation that the user is giving, because the audience will have already then seen the next slide.

A problem with automatically timed or pre-programmed actions is that the user does not know exactly when the next action will occur. In other words, it is hard to keep presentation pace with the pre-recorded timings of the actions.

### SUMMARY OF THE INVENTION

The above disadvantages or drawbacks have been eliminated by the present invention, which includes a system to perform slide presentation for presenting a sequence of slides on a display screen, at least one of the slides comprising plural animations, the system comprising:

means for switching display of slides in the sequence in response to input from a controller device;

means for tracking events associated with the slide presentation, the events comprising one or more of: an animation transition on the current slide, a transition from the current slide to a next slide, a transition to a final animation on the current slide, and a transition to final slide; and

means associated with the controller device for providing to a user a different tactile feedback dependent upon each detected event to notify the user about a current state of the slide presentation with respect to the sequence of slides and the plural animations.

The present invention can be implemented to include another screen. As another embodiment, the present invention includes a remote control presentation control device having one ore more buttons on it.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is a system diagram depicting elements of the present invention.

FIG. 2 is a flow chart of the presentation software implemented by a computer device having 2-way feedback remote presentation controller device of the present invention.

### DETAILED DESCRIPTION

The present invention is directed to a presentation controller device, which receives feedback from a visual slide presentation application executing on a computer device. The feedback is in the form of vibration (tactile feedback) or visual indication (signature or indicator), e.g., provided on a small display, but may be other forms.

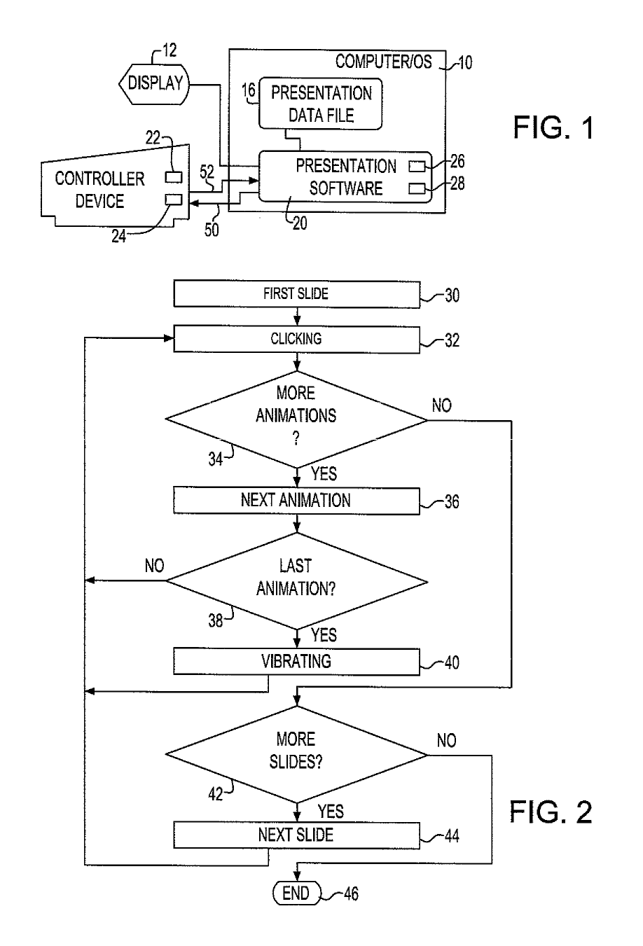

Reference is now had to FIG. 1, which shows an embodiment of the present invention. In a computer device 10 executing an operating system (O/S), there is a presentation data file 16 stored in computer memory storage and executable presentation software 20. The computer device 10 can be a handheld device, a PC, a server, etc. The O/S can be Windows®, Linux, Unix®, etc. The presentation file 16 is input to the executing presentation software 20 and the presentation display is generated via a display medium 12. The presentation software 20, which can be Lotus® Freelance®, Microsoft® Powerpoint®, etc., comprises an animation sequencer 26 and a timer 28. Animation sequencer 26 provides each animation to the display medium 12 and sends a wired or wireless feedback signal 50 to a presentation controller device 14, when the last animation is displayed on current slide. The presentation controller device 14 receives the feedback signal 50 through a feedback signal receiver 24 from the presentation software 20, when it is determined by the presentation system that the last animation is displayed on current slide or when a transition to next slide is expected. In one embodiment, the feedback signal 50 is a wireless signal (RF, Bluetooth®, and Infrared (IR), etc.) or could be physically wired connection. Based on the feedback signal 50, the presentation controller device 14, in one embodiment, activates a vibrator element 22. In another embodiment, it is understood that a tactile feedback (e.g., vibration or audio) may be used with signatures or indicators (e.g., display). Therefore, the presentation controller device 14 can vibrate, thus alerting the presenter affront a key slide transition e.g., when a final animation is performed on current slide. In response to the tactile feedback, a user may click a button on the presentation controller device 14 to send a signal 52 to control the change of animation and change of slides to the presentation software 20. In one embodiment, the signal 52 is a wireless signal (RF, Bluetooth®, and IR etc.), or could be physically wired connection. The presentation controller device 14 can be a wired device or a wireless device. In another embodiment, the controller device 14 can be programmed to perform automatic slide transition (i.e., a user does not require to give command for each slide or animation transition). At the automatic slide transition, the timer 28 sends a feedback signal 50 to presentation controller device 14 at a programmed time interval before a transition. Then, upon receiving the feedback signal 50, the controller device 14 provides to a user a different tactile feedback (e.g., vibration, buzz, double-buzz) related to respective different events (i.e., an animation transition, a slide transition, a transition to a final animation, and a transition to a final slide). For example, the controller device 14 may vibrate for X seconds before an animation transition. The controller device 14 may buzz for Y seconds before a final animation. The controller device 14 may double-buzz for Z seconds before a slide transition.

FIG. 2 shows an example method implemented by a user conducting a presentation with the presentation controller device 14 including programmed methodology of the presentation software executing on the computer. FIG. 2 shows following steps:
1. A presentation software starts presentation viewing on display;
2. At step 30, a first slide is displayed based on action initiated by a user via the presentation controller device 14;
3. At step 32, the user clicks a button on the presentation controller device 14;
4. At step 34, the presentation software 20 checks if animation remains on current slide;
5. If no animation remains on current slide, proceeds to step 42;
6. If animation remains on current slide, at step 36, the presentation software 20 provides a next animation to be displayed;
7. At step 38, the presentation software checks if the next animation is last animation on current slide;
8. If the next animation is the last animation on current slide, at step 40, the presentation software requires the computer device to generate feedback signal 50 for receipt by the presentation controller device 14. Upon receipt of feedback signal 50, the presentation controller device 14 vibrates or provides a tactile feedback with signatures or indicators as mentioned above;
9. Return to Step 32;
10. At step 42, the presentation software 20 checks if slides remain on current presentation file 16;
11. If slides remain, at step 44, next slide is displayed and then return to step 32;
12. If no slide remains, at step 46, the presentation is ended.

For one embodiment, manually timed actions are enabled whereby a controller device vibrates after the final action on a particular slide. Thus, the vibration indicates that the next click would be a transition to the next slide. For example, if a slide has two actions then, a series of steps that may be performed according to the invention include:

a. initiating presentation of a first action (click 1)

b. initiating presentation of a second (e.g. final) action (click 2)

c. then, in accordance with the invention, the controller device vibrates to indicate to the user that the final action has been performed and that the next click will cause a slide transition; and,

d. initiating presentation of a next slide (click 3)

For automatically timed actions, the presentation controller device could provide a tactile feedback, e.g., vibrate, buzz, double-buzz, at programmed time interval before the next transition. For example, it could vibrate 5 seconds before the slide or animation is about to be changed. A simple LCD display provided on the presentation controller device could also indicate to the user the number of seconds before a transition occurs.

In another embodiment, the present invention can include providing other types of feedback indication, e.g., on another display screen or predetermined area of display. This is possible for implementation that requires the use of a laptop for the user and a projector for the audience. The advantage of this embodiment is that the feedbacks received are directed to the user through the laptop and the presentation controller device.

In another embodiment, the present invention can include a remote presentation controller device having one or more buttons on it: For example, one button may initiate action transitions, while another button may be used to initiate slide transitions.

In another embodiment, the presentation controller device can have multiple buttons and a timer and it operates manually. Thus, in this embodiment, the presentation controller device only sends signals to the computer.

Although the embodiments of the present invention have been described in detail, it should be understood that various changes, substitutions and alternations can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A system to perform slide presentation for presenting a sequence of slides on a display screen, at least one of the slides comprising plural animations, said system comprising:
means for switching display of slides in said sequence in response to input from a controller device;
means for tracking events associated with said slide presentation, said events comprising one or more of: an animation transition on said current slide, a transition from said current slide to a next slide, a transition to a final animation on said current slide, and a transition to final slide; and
means associated with said controller device for providing to a user a different tactile feedback dependent upon each detected event to notify said user about a current state of said slide presentation with respect to said sequence of slides and said plural animations.

2. The system according to claim 1 farther comprising:
said presentation for presenting a sequence of slides is automated at a programmed timely manner; and
said means for switching display of slides automatically switches said display of slides in said sequence at said programmed timely manner.

3. A method to perform slide presentation for presenting a sequence of slides on a display screen, at least one of the slides comprising plural animations, said method comprising:
switching display of slides in said sequence in response to input from a controller device;
tracking events associated with said slide presentation, said events comprising one or more of: an animation transition on said current slide, a transition from said current slide to a next slide, a transition to a final animation on said current slide, and a transition to final slide; and
providing to a user a different tactile feedback dependent upon each detected event to notify said user about a current state of said slide presentation with respect to said sequence of slides and said plural animations.

4. The method according to claim 3 further comprising:
said presentation for presenting a sequence of slides is automated at a programmed timely manner; and
said switching display of slides automatically switches said display of slides in said sequence at said programmed timely manner.
